(19) United States
(12) Patent Application Publication
(10) Pub. No.: US 2025/0021125 A1
(43) Pub. Date: Jan. 16, 2025

(54) MULTI-SPRING BRAKE EMULATOR

(71) Applicant: CTS CORPORATION, Lisle, IL (US)

(72) Inventors: Ryan Andrew Wagner, Goshen, IN (US); John Clark, Granger, IN (US); David A. Kolberg, Granger, IN (US); William James Snell, Elkhart, IN (US)

(21) Appl. No.: 18/350,497

(22) Filed: Jul. 11, 2023

(51) Int. Cl. G05G 5/03; B60T 7/04; G05G 1/44

(52) U.S. Cl. CPC G05G 5/03; B60T 7/04; G05G 1/44

(57) ABSTRACT

Examples provide a brake pedal assembly including a pedal housing, a bracket for securement within a vehicle, and a pedal arm having a proximal portion pivotally supported by the pedal housing and a distal portion including a foot pad spaced from the bracket. The pedal arm pivots from an unactuated position to a fully actuated position in response to application of a force to the foot pad. A pedal emulator system provides variable operator feedback as the pedal arm pivots in response to the application of force. The pedal emulator system includes a first spring set engaged with the pedal arm at the unactuated position and operable to bias the pedal arm toward the unactuated position, and a second spring set engaged with the pedal arm only after the pedal arm pivots from the unactuated position to a first intercept position between the unactuated and fully actuated positions.

### FIELD

Embodiments, examples, and aspects described herein relate to pedal emulators for vehicles.

### SUMMARY

Brake-by-wire vehicle brake pedals do not utilize a conventional connection to the other components of a braking system, for example, a mechanical connection to a vacuum of hydraulic brake system. In some brake-by-wire systems, a sensor monitors how far a driver has pushed the brake pedal. This distance or “travel” that the pedal moves is used to determine the amount of braking force requested. A control unit or computer then determines how much hydraulic pressure is required, and an electric pump is used to generate that pressure and, for example, cause calipers to push on a brake disc to stop the vehicle.

Brake-by-wire systems have a number of advantages. However, brake-by-wire systems lack the feel of conventional brake systems that drivers are accustomed to. Accordingly, a pedal emulator that is reliable, compact, relatively inexpensive to manufacture, and capable of replicating the feel of a conventional brake pedal system is desired.

Thus, one example provides a brake pedal comprising: a pedal housing and bracket including a mounting surface configured for securement the pedal housing within a vehicle; a pedal arm having a proximal portion pivotally supported by the pedal housing and a distal portion including a foot pad spaced from the bracket, the pedal arm configured to pivot from an unactuated position to a fully actuated position in response to application of a force to the foot pad; and a pedal emulator system configured to provide variable operator feedback as the pedal arm pivots in response to the application of force. The pedal emulator system includes: a first spring set engaged with the pedal arm at the unactuated position and operable to bias the pedal arm toward the unactuated position, and a second spring set engaged with the pedal arm only after the pedal arm pivots from the unactuated position to a first intercept position between the unactuated and fully actuated positions, the second spring set operable in parallel with the first spring set to bias the pedal arm toward the unactuated position. The first and second sets of springs are arranged at different positions along the pedal arm.

In some aspects, the pedal emulator system further includes a friction device engaged with the first spring set for generating a resistance force against movement of the pedal, both toward and away from the unactuated position, through friction contact therewith.

In some aspects, a distance between a pivot axis of the pedal arm and a point of engagement of the first spring set on the pedal arm is less than a distance between the pivot axis of the pedal arm and a point of engagement of the second spring set on the pedal arm.

In some aspects, the pedal emulator system further includes a third spring set that is compressed only after the pedal arm pivots from the unactuated position to a second intercept position between the first intercept and fully actuated positions, the third spring set operable in parallel with the first and second spring sets to bias the pedal arm toward the unactuated position.

In some aspects, a distance between the pivot axis of the pedal arm and the point of engagement of the first spring set on the pedal arm is less than a distance between the pivot axis of the pedal arm and a point of engagement of the third spring set on the pedal arm, and the distance between the pivot axis of the pedal arm and the point of engagement of the third spring set on the pedal arm is less than the distance between the pivot axis of the pedal arm and the point of engagement of the second spring set on the pedal arm.

In some aspects, the first and second spring sets include different types of springs than the third spring set.

In some aspects, the first and second spring sets include compression springs, and the third spring set includes a torsion spring.

In some aspects, the pedal arm has a total angle of travel from the unactuated position to the fully actuated position, an angle of travel between the unactuated position and the first intercept position is approximately one third the total angle, an angle of travel between the first intercept position and the second intercept position is approximately one third the total angle, and an angle of travel between the second intercept position and the fully actuated position is approximately one third the total angle.

In some aspects, the first spring set includes two nested springs.

In some aspects, the second spring set is disposed in a first housing, and the first housing is in contact with the pedal arm only after the pedal arm pivots from the unactuated position to the first intercept position.

In some aspects, the brake pedal assembly further comprises a set of position sensors disposed in a sensor housing and configured to measure the position of the pedal arm, the set of position sensors including a subset of inductive sensors and a subset of vectored Hall sensors.

Another example provides a pedal emulator system comprising: a first spring set engaged with a pedal arm at an unactuated position and operable to bias the pedal arm toward the unactuated position, and a second spring set engaged with the pedal arm only after the pedal arm pivots from the unactuated position to a first intercept position between the unactuated and fully actuated positions, the second spring set operable in parallel with the first spring set to bias the pedal arm toward the unactuated position, wherein the first and second sets of springs are arranged at different positions within the pedal emulator system.

In some aspects, the pedal emulator system further comprises a friction device engaged with the first spring set for generating a resistance force against movement of the pedal, both toward and away from the unactuated position, through friction contact therewith.

In some aspects, the pedal emulator system further comprises a third spring set that is compressed only after the pedal arm pivots from the unactuated position to a second intercept position between the first intercept and fully actuated positions, the third spring set operable in parallel with the first and second spring sets to bias the pedal arm toward the unactuated position.

In some aspects, the first and second spring sets include different types of springs than the third spring set.

In some aspects, the first and second spring sets include compression springs, and the third spring set includes a torsion spring.

In some aspects, the first spring set includes two nested springs.

In some aspects, the second spring set is disposed in a spring housing, and the spring housing is in contact with the pedal arm only after the pedal arm pivots from the unactuated position to the first intercept position.

Another example provides a brake pedal assembly comprising: a pedal housing and a bracket including a mounting surface configured for securement of the pedal housing within a vehicle; a pedal arm having a proximal portion pivotally supported by the pedal housing and a distal portion including a foot pad spaced from the bracket, the pedal arm configured to pivot from an unactuated position to a fully actuated position in response to application of a force to the foot pad; and a pedal emulator system configured to provide variable operator feedback as the pedal arm rotates around the pivot in response to the application of force. The pedal emulator system includes: a set of springs that selectively engages the pedal arm, the set of springs configured to provide variable operator feedback as the pedal arm pivots in response to the application of force, wherein the set of springs is inactive through a first range of travel from the unactuated position.

In some aspects, the set of springs is disposed in a spring housing, and the housing is in contact with the pedal arm only after the pedal arm pivots through the first range of travel.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate examples, instances, and/or aspects of concepts that include the claimed subject matter, and explain various principles and advantages of examples, instances, and/or aspects.

FIG. 1 is a perspective view of a brake pedal assembly, according to some aspects.

FIG. 2 is a plan view of a brake pedal assembly, according to some aspects.

FIG. 3 is a schematic view a sensor system included in a brake pedal assembly, according to some aspects.

FIG. 4 is a schematic a sensor system in a brake pedal assembly, according to some aspects.

FIG. 5 is a cross-sectional view of a brake pedal assembly in an unactuated position, according to some aspects.

FIG. 6 is a cross-sectional view of a brake pedal assembly in an actuated position, according to some aspects.

FIG. 7 is a cross-sectional view of a brake pedal assembly in an actuated position, according to some aspects.

FIG. 8 is a force-displacement curve of a pedal emulator system, according to some aspects.

FIG. 9 is a cross-sectional view of a brake pedal assembly in an unactuated state, according to some aspects.

FIG. 10 is a cross-sectional view of a brake pedal assembly in an actuated position, according to some aspects.

FIG. 11 is a cross-sectional view of a brake pedal assembly in an actuated position, according to some aspects.

FIG. 12 is a force-displacement curve of a pedal emulator system, according to some aspects.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. It should be understood that the description of specific embodiments is not intended to limit the disclosure from covering all modifications, equivalents, and alternatives falling within the spirit and scope of the disclosure. Also, it is to be understood that the phraseology and terminology used herein is for the purpose of description and should not be regarded as limiting.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

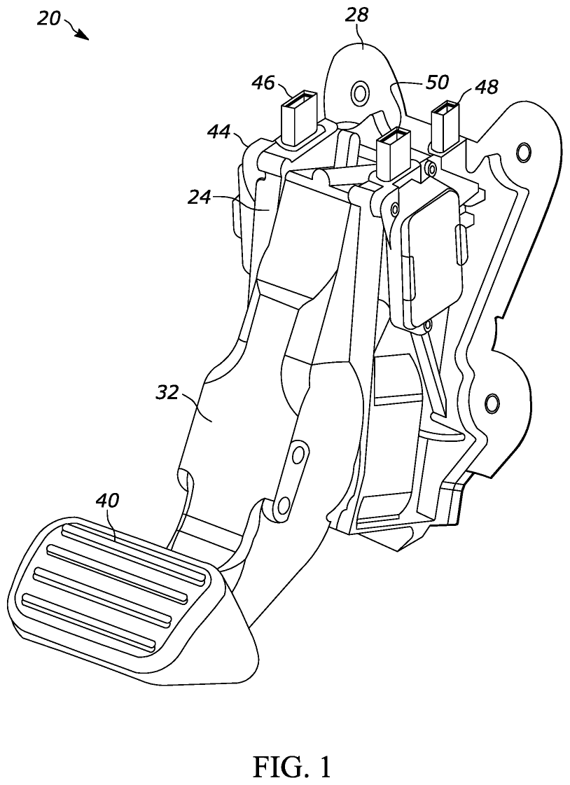

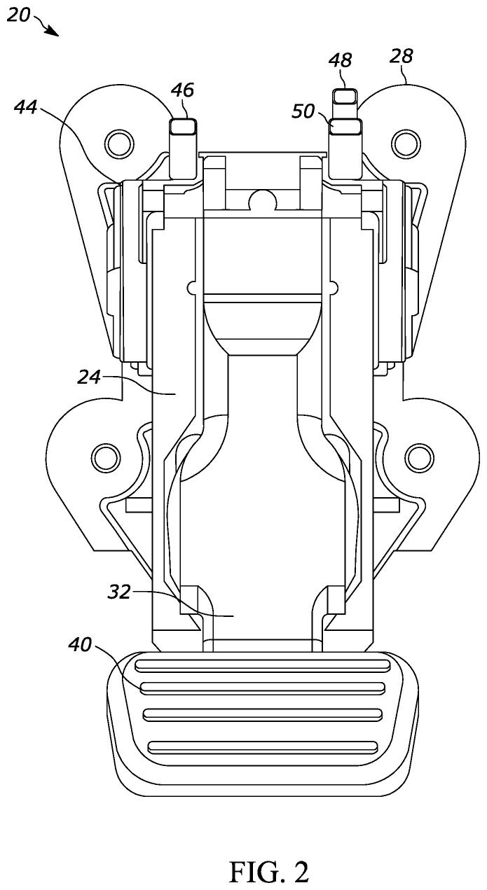

FIGS. 1 and 2 illustrate a brake pedal assembly 20, according to some aspects. The brake pedal assembly 20 includes a housing 24 with a bracket 28 for mounting the brake pedal assembly 20 within a vehicle. A pedal arm, or simply “pedal” 32 extends from the housing 24 in which it is supported by the bracket 28 at a rotary axis or pivot 36. A distal portion of the pedal 32, spaced from the bracket 28, can be provided with a foot pad or footrest 40 for contact by the driver's foot. The pedal 32 is configured to pivot from an unactuated position to a fully actuated position in response to application of a force to the foot pad 40. The fully actuated position of the pedal 32 is a position at which the pedal arm has pivoted a maximum predetermined angle of travel, after which additional travel of the pedal 32 is blocked by, for example, one or more components of the brake pedal assembly 20 (e.g., an internal wall of the housing 44).

In some constructions, the pedal assembly 20 is a pedal and sensor assembly having an integrated position sensor for tracking the position of the pedal 32. The pedal assembly 20 can be connected for signal communication with an electronic control module (ECM) of the vehicle. For example, the brake pedal assembly 20 also includes a sensor housing 44 and a sensor assembly 54 disposed within the housing 24 for detecting a linear and/or a rotational position of the pedal 32. The sensor housing 44 includes a first connector 46, a second connector 48, and a third connector 50 for outputting position sensor data from the sensor assembly 54 to the vehicle ECM.

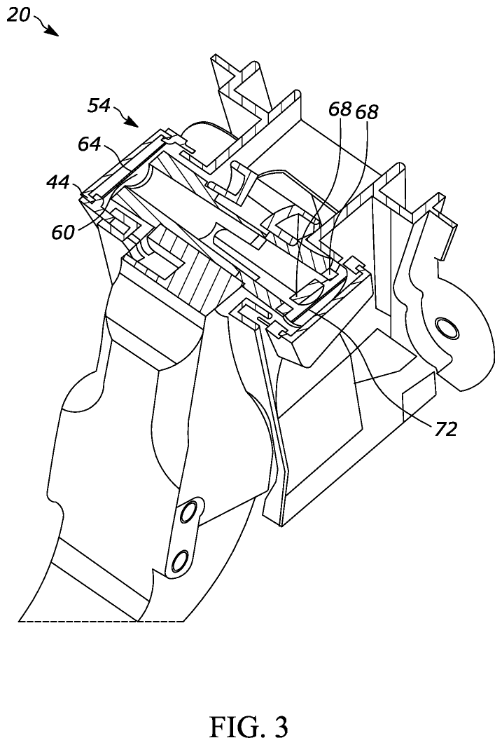

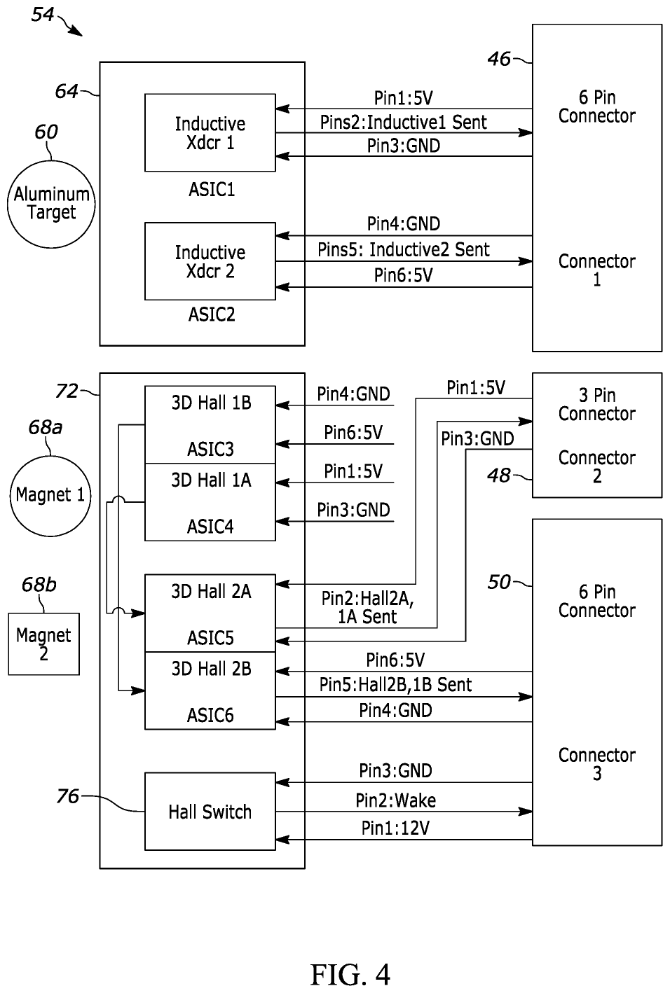

FIG. 3 illustrates the brake pedal assembly 20 with a portion of the sensor housing 22 removed, exposing the sensor assembly 54. Only a portion of the pedal arm 32 that is proximal to the sensor housing 44 is shown, with the understanding that the pedal 32 extends further in the downward direction of the view toward the foot pad 40. The sensor assembly 54 includes, in some examples, six independent non-contacting sensors and a switch (described in greater detail below with respect to FIG. 4). However, in another example, the sensor assembly 54 includes more than six sensors, and in another example, the sensor assembly includes less than six sensors. The sensor assembly 54 includes an inductive side and a Hall side opposite the inductive side. For example, the inductive side of the sensor assembly 54 includes an inductive target 60 (e.g., an aluminum target) and an inductive-side printed circuit board assembly (“PCBA”) 64 including inductive coil sensors for sensing and outputting sensor data associated with the inductive target 60. The Hall side of the sensor assembly 54 includes magnets 68 and a Hall-side PCBA 72 including vectored Hall effect sensors for sensing and outputting sensor data associated with the magnets 68.

FIG. 4 schematically illustrates the sensor assembly 54, according to some examples. In some instances, the inductive-side PCBA 64 includes first and second inductive sensors implemented as application specific integrated circuits (“ASICs”) and referred to herein as ASIC1 and ASIC2, respectively. Each inductive sensor ASIC1 and ASIC2 includes three pins electrically connected to the first connector 46. For example, the first inductive sensor ASIC1 receives, via the first connector 46 and a 5 Volt (“V”) signal at Pin1 and a ground, or reference signal at Pin3. The first inductive sensor ASIC1 outputs, at Pin3, first inductive sensor data to the first connector 46. The second inductive sensor ASIC2 receives, via the first connector 46, a ground, or reference signal at Pin4 and a 5 Volt (“V”) signal at Pin6. The second inductive sensor ASIC2 outputs, at Pin5, second inductive sensor data to the first connector 46. Providing two inductive sensors ASIC1 and ASIC2 on the inductive-side PCBA 64 enables redundancy of pedal arm position sensing in the event of failure or error of one of the inductive sensors ASIC1 or ASIC2. However, the inductive-side PCBA 64 may include more than two inductive sensors or less than two inductive sensors.

In some instances, the Hall-side PCBA 72 includes a Hall effect switch 76 and four vectored, or three dimensional (“3D”), Hall effect sensors respectively referred to herein as ASIC3, ASIC4, ASIC5, and ASIC6. Hall effect sensors ASIC4 and ASIC5 are electrically connected to one another and to the second connector 48. For example, the second connector 48 is a three pin connector configured to provide a 5 V signal to Pin1 of Hall effect sensors ASIC4 and ASIC5 and a ground, or reference signal to Pin3 of Hall effect sensors ASIC4 and ASIC5. Hall effect sensor ASIC4 is configured to measure and output Hall effect sensor data associated with a first magnet 68a to Hall effect sensor ASIC5. Hall effect sensor ASIC5 is configured to measure Hall effect sensor data associated with a second magnet 68b, and output, at Pin2, both the sensor data measured by ASIC4 and the sensor data measured by ASIC5 to the second connector 48.

Hall effect sensors ASIC3 and ASIC6 are electrically connected to one another and to the third connector 50. For example, the third connector 50 is a six pin connector configured to provide a 5 V signal to Pin6 of Hall effect sensors ASIC3 and ASIC6 and a ground, or reference signal to Pin4 of Hall effect sensors ASIC3 and ASIC6. Hall effect sensor ASIC3 is configured to measure and output Hall effect sensor data associated with the first magnet 68a to Hall effect sensor ASIC6. Hall effect sensor ASIC6 is configured to measure Hall effect sensor data associated with the second magnet 68b, and output, at Pin5, both the sensor data measured by ASIC3 and the sensor data measured by ASIC6 to the third connector 50.

The Hall effect switch 76 includes three pins electrically connected to the third connector 50. For example, the Hall effect switch 76 is configured to receive, via the third connector 50, a 12 V signal at Pin1 and a ground or reference signal at Pin3. The Hall switch is configured to output, at Pin2, a wake signal to third connector 50.

Providing four inductive sensors ASIC3, ASIC4, ASIC5, and ASIC6 on the Hall-side PCBA 72 enables redundancy of pedal arm position sensing in the event of failure or error of any inductive sensors ASIC1 and/or ASIC2 and/or a Hall effect sensor ASIC3, ASIC4, ASIC5, and/or ASIC6. However, the Hall-side PCBA 72 may include more than four Hall effect sensors or less than four Hall effect sensors.

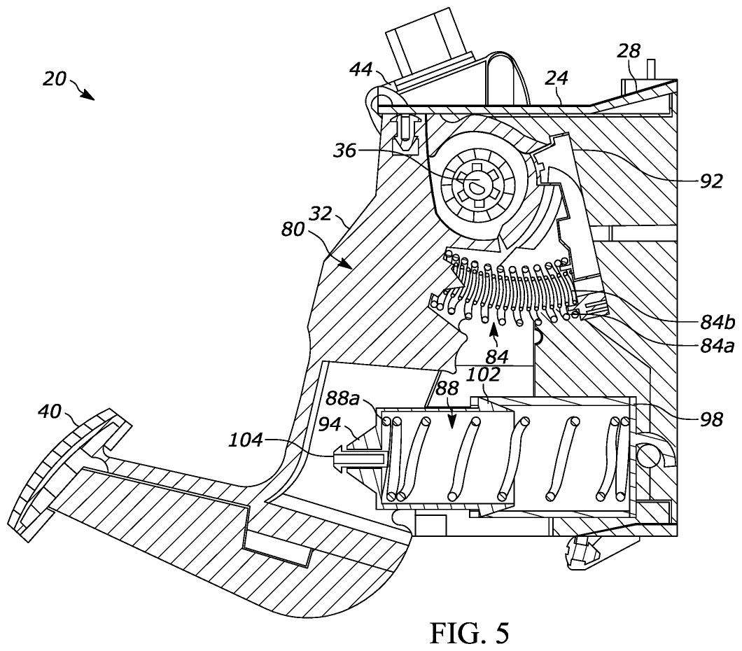

FIG. 5 illustrates a cross-sectional view of the brake pedal assembly 20 in an unactuated position, including a multi-stage pedal emulator system 80. In the illustrated example, the multi-stage pedal emulator system 80 is a two-stage pedal emulator system 80 designed to replicate the feel of a conventional braking system by providing variable operator feedback as the pedal arm 32 pivots in response to the application of force on the foot pad 40 by the driver.

The two-stage pedal emulator system 80 includes a first spring set 84 and a second spring set 88. The first spring set 84 is engaged with the pedal arm 32 at the unactuated position and operable to bias the pedal arm 32 toward the unactuated position. In the illustrated example, the first spring set 84 includes two nested springs 84a and 84b. The two nested springs 84a and 84b operate in parallel with one another, and each of the nested springs 84a and 84b has a spring constant such that, when external force is removed from the pedal 32, each nested spring 84a and 84b is operable to bias the pedal 32 to the unactuated position. The first spring set 84 is engaged with the pedal arm 32 and active through an entire angle of travel of the pedal arm 32 from the unactuated position illustrated in FIG. 4 to a fully actuated position. The springs included in the first spring set 84 are, for example compression springs. However, other types of springs are contemplated.

The first spring set 84 is engaged with a friction device 92 for generating a resistance force against movement of the pedal arm 32. The friction device 92 operates to add friction as the pedal arm 32 is moved further from the first limit position. In other words, the friction device 92 is increasingly actuated directly in response to movement of the pedal 32 away from the unactuated position and toward an actuated position. The friction device 92 relaxes the frictional resistance as the pedal arm 32 moves back toward the unactuated position.

In the illustrated example, the second spring set 88 includes one spring 88a. However, the second spring set 88 may include additional springs. The springs included in the second spring set 88 are, for example compression springs. However, other types of springs for use in the second spring set 88 are contemplated. The second spring set 88 is disposed in a cylindrical spring housing 94 having an outer portion, or shroud 98 and inner portion 102 received by the shroud 98. The shroud 98 of the spring housing 94 is secured to the bracket 28. The spring housing 94 supports the second spring set 88 and protects the second spring set 88 from debris.

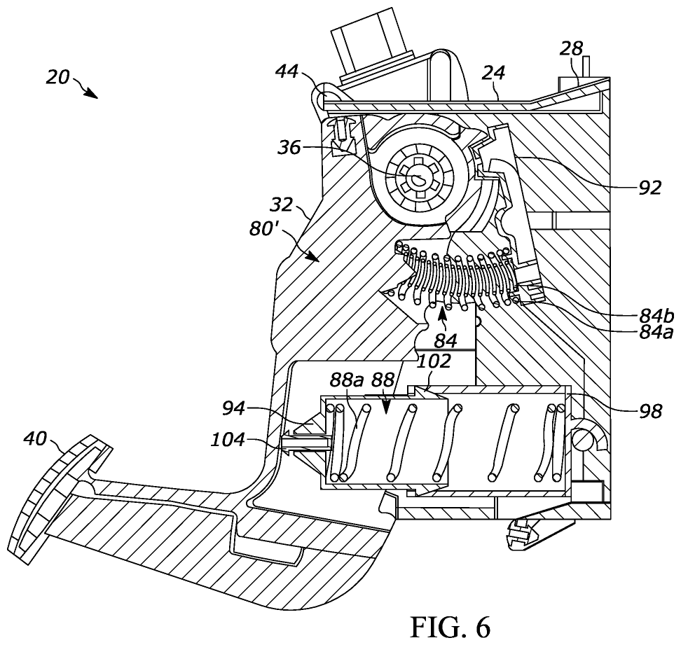

While the first spring set 84 is active through the entire angle of travel of the pedal arm 32, the second spring set 88 is not active during a first angle of travel of the pedal arm 32. Rather, the spring housing 94 includes a pedal contact point 104 that is engaged with the pedal arm 32 only after the pedal arm 32 pivots from the unactuated position to a first intercept position (FIG. 6) between the unactuated and fully actuated positions. Before the pedal arm 32 has pivoted from the unactuated position to the first intercept position, a gap is present between the pedal contact point 104 of the spring housing 94 and the pedal arm 32.

In the illustrated examples, the first spring set 84 and second spring set 88 are arranged such that a distance between the pivot 36 and the point of engagement of the first spring set 84 is less than a distance between the pivot 36 and the pedal contact point 104 of the second spring set 88. For example, a hollow chamber within the pedal arm 32 allows a predetermined amount of travel of the pedal arm 32 before the second spring set 84 is engaged.

For example, FIG. 6 illustrates a cross-sectional view of the brake pedal assembly 20 including the two-stage pedal emulator system 80 when the pedal arm 32 is at the first intercept position. After the pedal arm 32 engages with the pedal contact point 104 of the spring housing 94 at the first intercept position, the second spring set 88 is operates in parallel with the first spring set 84 to bias or provide counterforce to the pedal arm 32 toward the unactuated position. In some instances, an angle of travel of the pedal arm 32 between the unactuated position and the first intercept position is approximately one third a total angle of travel of the pedal arm 32 from the unactuated position to the fully actuated position.

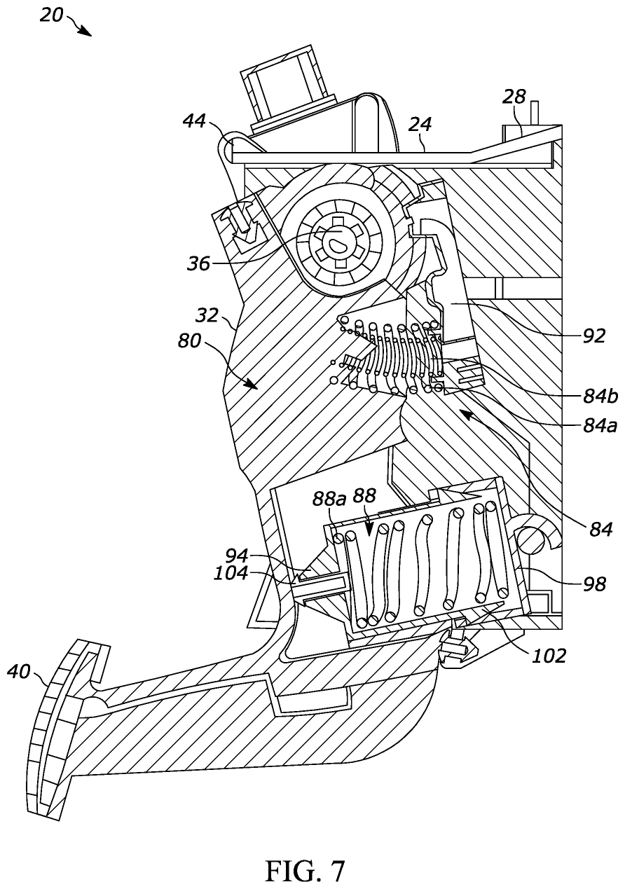

FIG. 7 illustrates a cross-sectional view of the brake pedal assembly 20 including the two-stage pedal emulator system 80 when the pedal am 32 is at the fully actuated position. An angle of travel between the first intercept position and the fully actuated position is approximately two thirds third the total angle of travel, and, in the fully actuated position, the pedal arm 32 has traveled through an entire angle of travel of the pedal arm 32.

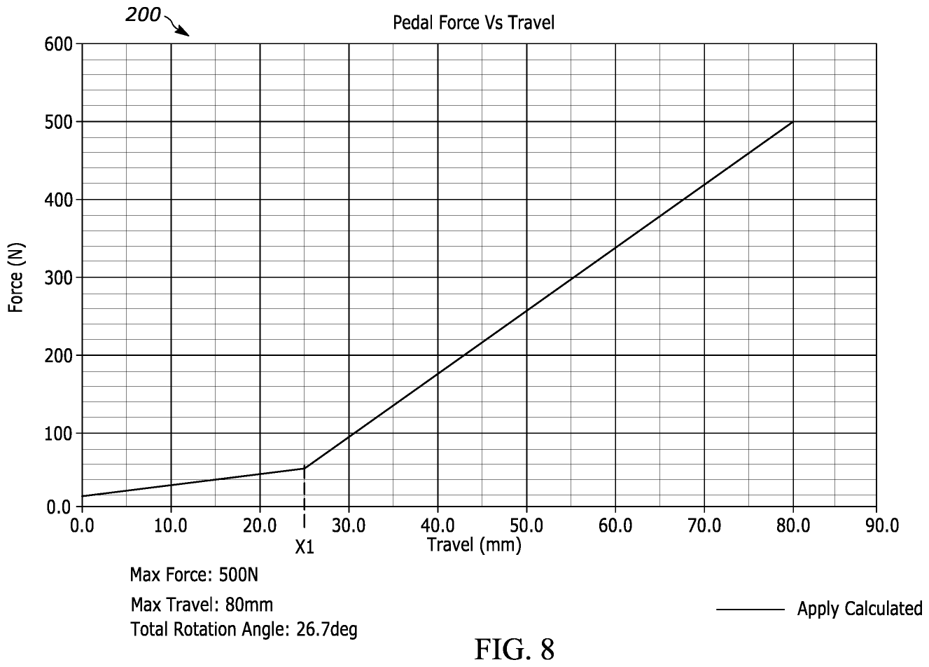

FIG. 8 illustrates an example force curve 200 of the biasing force of the two-stage pedal emulator system 80 versus the linear travel of the pedal arm 32. In some instances, the total angle of travel of the pedal arm 32 is between approximately 20 degrees and approximately 30 degrees (e.g., approximately 26 degrees). The total angle of travel of the pedal arm 32 corresponds to a total linear travel distance of approximately 80 mm (e.g., measured from the unactuated position of the pedal arm 32 to the fully actuated position of the pedal arm 32). However, the total travel distance of the pedal arm 32 is not limited to the values descried herein. For example, the total linear travel distance of the pedal arm 32 may be greater than 80 mm or less than 80 mm.

The biasing force of the two-stage pedal emulator system 80 (e.g., of the first spring set 84 and the second spring set 88) varies with respect to the distance of travel of the pedal arm 32. As shown in FIG. 8, the force curve 200 exhibits an inflection point X1, such that a rate of change of the biasing force varies non-linearly through the travel of the pedal arm 32. The inflection point X1, which occurs, for example, between approximately 22.5 mm and approximately 27.5 mm (e.g., approximately 25 mm), corresponds to the first intercept position of the pedal arm 32. The linear travel of the pedal arm 32 from the unactuated position to the first intercept point, as reflected by inflection point X1, therefore corresponds to the first stage of the two-stage pedal emulator system 80. During the first stage, while only the first spring set 84 is engaged with the pedal arm 32, the biasing force exhibited by the emulator system 80 against the pedal arm 32 increases at a first rate relative to the angle of travel of the pedal arm 32. After the pedal arm 32 reaches the first intercept position, while both the first spring set 84 and the second spring set 88 are engaged with the pedal arm 32, the biasing force exhibited by the pedal emulator system 80 against the pedal arm 32 increases at a second rate relative to the angle of travel of the pedal arm 32, where the second rate is greater than the first rate. The maximum force output by the two-stage pedal emulator system 80 (e.g., the biasing force against the pedal arm 32 when the pedal arm 32 is in the fully actuated position) is dependent on, for example, respective spring constants of springs included in the first spring set 84 and the second spring set 88. In the illustrated example, the maximum force output by the two-stage pedal emulator system 80 is approximately 500 Newtons (“N”). However other values of maximum force are contemplated.

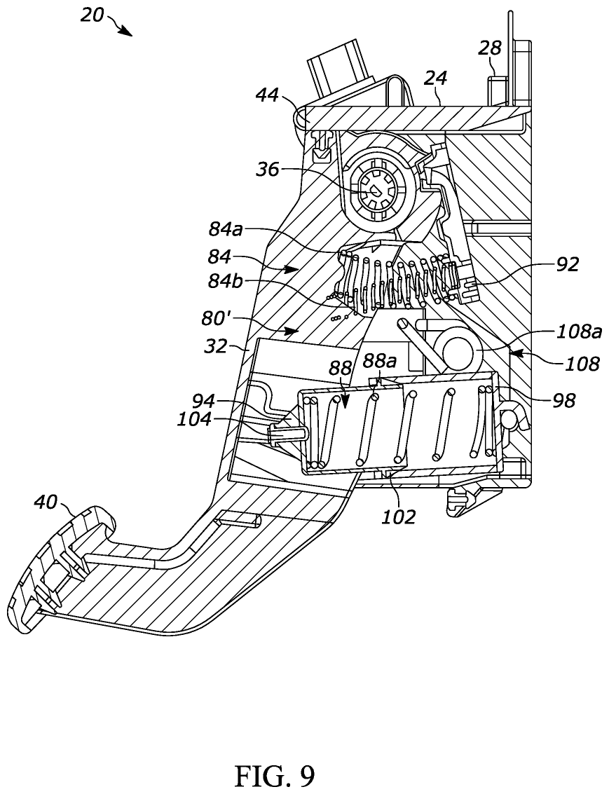

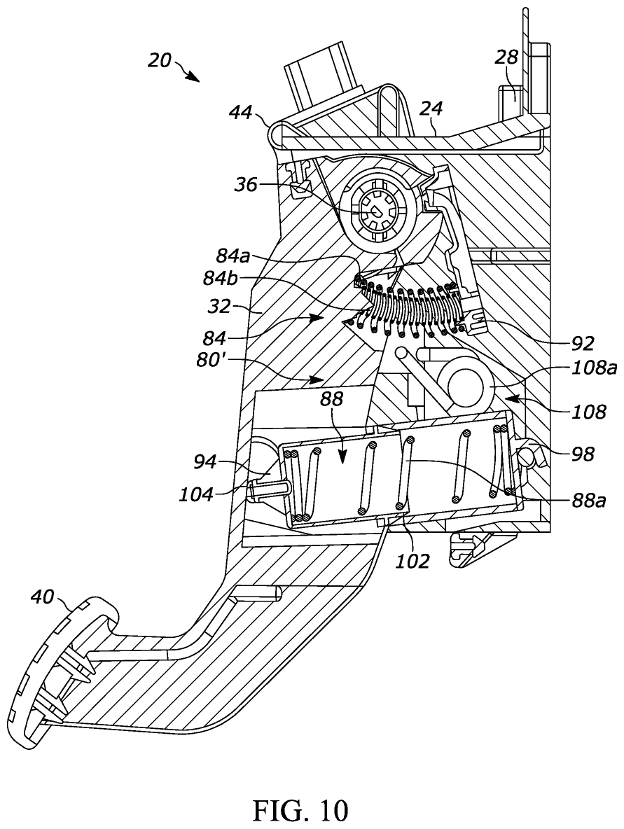

Referring now to FIGS. 9-11, in some instances, the brake pedal assembly 20 includes a three-stage pedal emulator system 80′ rather than the two-stage pedal emulator system 80 illustrated with respect to FIGS. 5-7. Operation of the three-stage pedal emulator system 80′ is similar to that of the two-stage pedal emulator system 80. Therefore, similar components of the two-stage pedal emulator system 80 and the three-stage pedal emulator system 80′ are identified with common reference numerals. For example, the three-stage pedal emulator system 80′ includes the first spring set 84 and the second spring set 88. The three-stage pedal emulator system 80′ additionally incudes a third spring set 108 including at least one spring 108a. In the illustrated example, the spring 108a included in the third spring set 108 is a torsion spring. The third spring set 108 is arranged between the first spring set 84 and the second spring set 88 such that the distance between the pivot axis of the pedal arm 32 and the point of engagement of the first spring set 84 on the pedal arm 32 is less than a distance between the pivot axis of the pedal arm 32 and a point of engagement of the third spring set 108 on the pedal arm 32. The distance between the pivot axis of the pedal arm 32 and the point of engagement of the third spring set 108 on the pedal arm 32 is less than the distance between the pivot axis of the pedal arm 32 and the point of engagement of the second spring set 88 on the pedal arm 32.

The third spring set 108 is operable in parallel with the first spring set 84 and the second spring set 88 to bias the pedal arm 32 toward the unactuated position. However, the third spring set 108 is not engaged with the pedal arm 32 when the pedal arm 32 is in the unactuated position. For example, FIGS. 9-11 respectively illustrate the three-stage pedal emulator system 80′ when the pedal arm 32 is in the actuated position, a first intercept position, and a second intercept position. As shown in FIGS. 9-11, the third spring set 108 is engaged with the pedal arm 32 and compressed only after the pedal arm 32 pivots from the unactuated position to a second intercept position between the first intercept and fully actuated positions of the pedal arm 32.

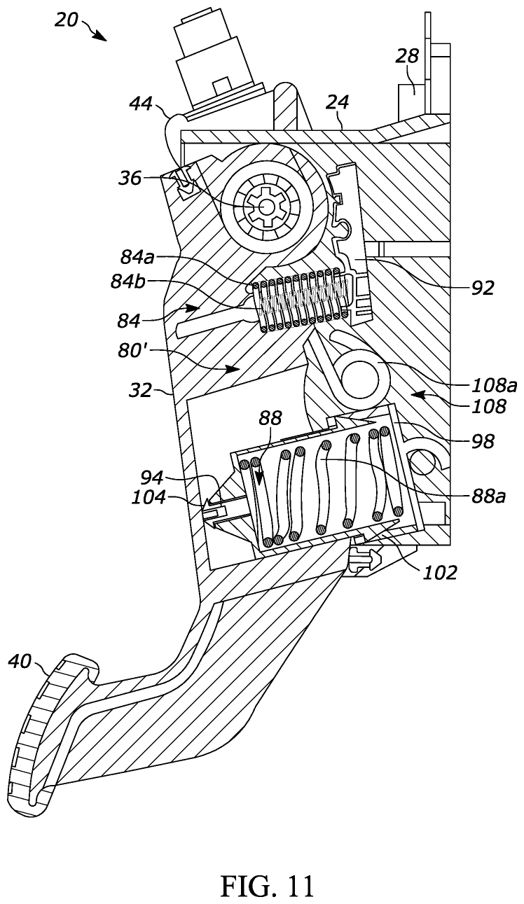

In some instances, the second intercept position of the pedal arm 32 is between the first intercept position and the fully actuated position such that an angle of travel of the pedal am 32 between the first intercept position (e.g., the point at which the second spring set 88 becomes engaged with the pedal arm 32) and the second intercept position (e.g., the point at which the third spring set 108 becomes engaged with the pedal arm 32) is approximately one third the total angle of travel of the pedal arm 32. Similarly, an angle of travel of the pedal arm 32 between the second intercept position and the fully actuated position is approximately one third the total angle of the travel of the pedal arm 32. When the pedal arm 32 is engaged with the third spring set 108, such as in the example illustrated in FIG. 11, the third spring set 108 is active and operable to provide variable operator feedback, or biasing force against the pedal arm 32, as the pedal arm 32 pivots from the second intercept position to the fully actuated position.

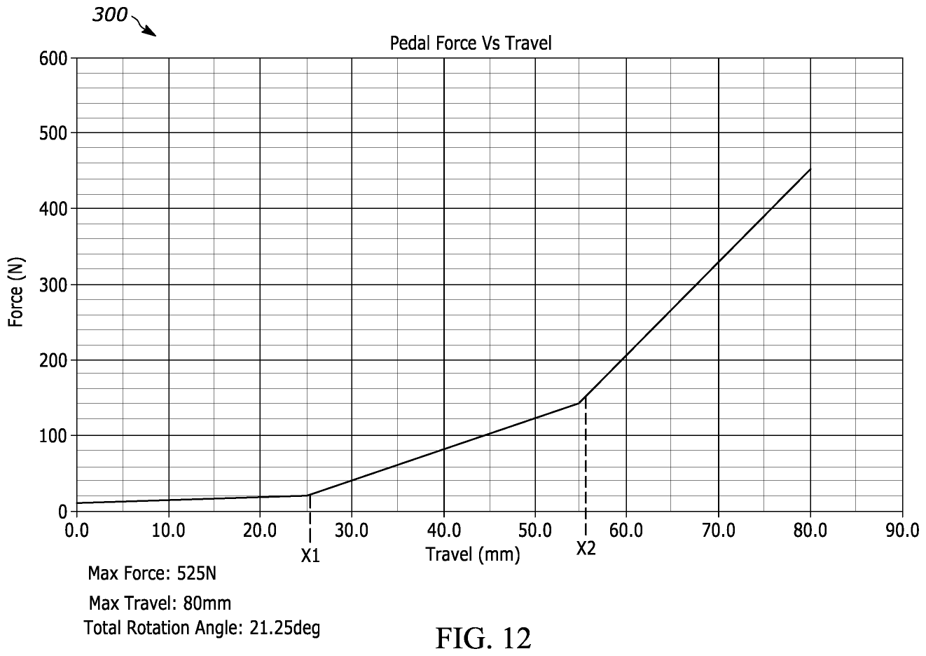

Referring now to FIG. 12, an example force curve 300 of the biasing force of the three-stage pedal emulator system 80′ versus the linear travel of the pedal arm 32 is illustrated. In some instances, the total angle of travel of the pedal arm 32 having the three-stage pedal emulator system 80′ may be between approximately 16.25 degrees and approximately 26.25 degrees (e.g., approximately 21.25 degrees and the total linear travel distance of the pedal arm 32 is between approximately 75 mm and approximately 85 mm (e.g., 80 mm). However, in some instances, the total angle of travel of the pedal arm 32 is between approximately 21.7 degrees and approximately 31.7 degrees (e.g., approximately 26.7 degrees).

The biasing force of the three-stage pedal emulator system 80′ varies with respect to the distance of travel of the pedal arm 32. As shown in FIG. 12, the force curve 300 exhibits a first inflection point X1 and a second inflection point X2, such that a rate of change of the biasing force varies non-linearly through the travel of the pedal arm 32. Similar to the inflection point X1 of the force curve 200 described above with respect to FIG. 8, the first inflection point X1 of the force curve 300, which occurs at approximately 25 mm, corresponds to the first intercept position of the pedal arm 32. The linear travel of the pedal arm 32 from the unactuated position to the first intercept position, as reflected by the first inflection point X1, therefore corresponds to the first stage of the three-stage pedal emulator system 80′. During the first stage, while only the first spring set 84 active, the biasing force exhibited by the emulator system 80 against the pedal arm 32 increases at a first rate relative to the angle of travel of the pedal arm 32. After the pedal arm 32 reaches the first intercept point, while both the first spring set 84 and the second spring set 88 are engaged with the pedal arm 32, the biasing force exhibited by the three-stage pedal emulator system 80′ against the pedal arm 32 increases at a second rate relative to the angle of travel of the pedal arm 32, where the second rate is greater than the first rate. Similarly, after the pedal arm 32 reaches the second intercept point, while both the first spring set 84, the second spring set 88, and the third spring set 108 are engaged with the pedal arm 32, the biasing force exhibited by the three-stage pedal emulator system 80′ against the pedal arm 32 increases at a third rate relative to the angle of travel of the pedal arm 32, where the third rate is greater than the first and second rates.

The maximum force output by the three-stage pedal emulator system 80′ (e.g., the biasing force against the pedal arm 32 when the pedal arm 32 is in the fully actuated position) is dependent on, for example, respective spring constants of springs included in the first spring set 84, the second spring set 88, and the third spring set 108. In the illustrated example, the maximum force output by the three-stage pedal emulator system 80′ is approximately 525 N. However other values of maximum force are contemplated. For example, spring constants of springs included in any one of the first spring set 84, the second spring set 8, and/or the third spring set 18 may be modified such that the maximum biasing force output by the three-stage pedal emulator system 80′ is greater than 525 N (e.g., approximately 550 N) or less than 525 N (e.g., approximately 500 N).

In the foregoing specification, specific examples have been described. However, one of ordinary skill in the art appreciates that various modifications and changes may be made without departing from the scope of the invention as set forth in the claims below. For example, the brake pedal assembly 20 may include a pedal emulator system having additional stages of springs, such as fourth, fifth, and/or sixth stage springs. In such instances, the pedal emulator system experiences additional stages of force response during operation of the brake pedal assembly 20. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A brake pedal assembly comprising:
a pedal housing and bracket including a mounting surface configured for securement the pedal housing within a vehicle;
a pedal arm having a proximal portion pivotally supported by the pedal housing and a distal portion including a foot pad spaced from the bracket, the pedal arm configured to pivot from an unactuated position to a fully actuated position in response to application of a force to the foot pad; and
a pedal emulator system configured to provide variable operator feedback as the pedal arm pivots in response to the application of force,
wherein the pedal emulator system includes:
a first spring set engaged with the pedal arm at the unactuated position and operable to bias the pedal arm toward the unactuated position, and
a second spring set engaged with the pedal arm only after the pedal arm pivots from the unactuated position to a first intercept position between the unactuated and fully actuated positions, the second spring set operable in parallel with the first spring set to bias the pedal arm toward the unactuated position,
wherein the first and second sets of springs are arranged at different positions along the pedal arm.

2. The brake pedal assembly of claim 1, wherein the pedal emulator system further includes a friction device engaged with the first spring set for generating a resistance force against movement of the pedal, both toward and away from the unactuated position, through friction contact therewith.

3. The brake pedal assembly of claim 1, wherein a distance between a pivot axis of the pedal arm and a point of engagement of the first spring set on the pedal arm is less than a distance between the pivot axis of the pedal arm and a point of engagement of the second spring set on the pedal arm.

4. The brake pedal assembly of claim 3, wherein the pedal emulator system further includes a third spring set that is compressed only after the pedal arm pivots from the unactuated position to a second intercept position between the first intercept and fully actuated positions, the third spring set operable in parallel with the first and second spring sets to bias the pedal arm toward the unactuated position.

5. The brake pedal assembly of claim 4, wherein a distance between the pivot axis of the pedal arm and the point of engagement of the first spring set on the pedal arm is less than a distance between the pivot axis of the pedal arm and a point of engagement of the third spring set on the pedal arm, and the distance between the pivot axis of the pedal arm and the point of engagement of the third spring set on the pedal arm is less than the distance between the pivot axis of the pedal arm and the point of engagement of the second spring set on the pedal arm.

6. The brake pedal assembly of claim 4, wherein the first and second spring sets include different types of springs than the third spring set.

7. The brake pedal assembly of claim 6, wherein the first and second spring sets include compression springs, and the third spring set includes a torsion spring.

8. The brake pedal assembly of claim 4, wherein
the pedal arm has a total angle of travel from the unactuated position to the fully actuated position,
an angle of travel between the unactuated position and the first intercept position is approximately one third the total angle,
an angle of travel between the first intercept position and the second intercept position is approximately one third the total angle, and
an angle of travel between the second intercept position and the fully actuated position is approximately one third the total angle.

9. The brake pedal assembly of claim 1, wherein the first spring set includes two nested springs.

10. The brake pedal assembly of claim 1, wherein
the second spring set is disposed in a first housing, and
the first housing is in contact with the pedal arm only after the pedal arm pivots from the unactuated position to the first intercept position.

11. The brake pedal assembly of claim 1, further comprising
a set of position sensors disposed in a sensor housing and configured to measure the position of the pedal arm, the set of position sensors including a subset of inductive sensors and a subset of vectored Hall sensors.

12. A pedal emulator system comprising:
a first spring set engaged with a pedal arm at an unactuated position and operable to bias the pedal arm toward the unactuated position, and
a second spring set engaged with the pedal arm only after the pedal arm pivots from the unactuated position to a first intercept position between the unactuated and fully actuated positions, the second spring set operable in parallel with the first spring set to bias the pedal arm toward the unactuated position,
wherein the first and second sets of springs are arranged at different positions within the pedal emulator system.

13. The pedal emulator system of claim 12, further comprising a friction device engaged with the first spring set for generating a resistance force against movement of the pedal, both toward and away from the unactuated position, through friction contact therewith.

14. The pedal emulator system of claim 12, further comprising a third spring set that is compressed only after the pedal arm pivots from the unactuated position to a second intercept position between the first intercept and fully actuated positions, the third spring set operable in parallel with the first and second spring sets to bias the pedal arm toward the unactuated position.

15. The pedal emulator system of claim 14, wherein the first and second spring sets include different types of springs than the third spring set.

16. The pedal emulator system of claim 14, wherein the first and second spring sets include compression springs, and the third spring set includes a torsion spring.

17. The pedal emulator system of claim 12, wherein the first spring set includes two nested springs.

18. The pedal emulator system of claim 12, wherein
the second spring set is disposed in a spring housing, and
the spring housing is in contact with the pedal arm only after the pedal arm pivots from the unactuated position to the first intercept position.

19. A brake pedal assembly comprising:
a pedal housing and a bracket including a mounting surface configured for securement of the pedal housing within a vehicle;
a pedal arm having a proximal portion pivotally supported by the pedal housing and a distal portion including a foot pad spaced from the bracket, the pedal arm configured to pivot from an unactuated position to a fully actuated position in response to application of a force to the foot pad; and
a pedal emulator system configured to provide variable operator feedback as the pedal arm rotates around the pivot in response to the application of force,
the pedal emulator system including:
a set of springs that selectively engages the pedal arm, the set of springs configured to provide variable operator feedback as the pedal arm pivots in response to the application of force, wherein the set of springs is inactive through a first range of travel from the unactuated position.

20. The brake pedal assembly of claim 19, wherein the set of springs is disposed in a spring housing, and
the housing is in contact with the pedal arm only after the pedal arm pivots through the first range of travel.
